(19) United States
(12) Patent Application Publication
(10) Pub. No.: US 2008/0036118 A1
(43) Pub. Date: Feb. 14, 2008

(54) Method for the Production of Polyacetal Plastic Composites and Device Suitable for the Same

(75) Inventors: Marco Prigandt, Kahl am Main (DE); Juergen Riecke, Aschau (DE)

Correspondence Address: CONNOLLY BOVE LODGE & HUTZ, LLP, P O BOX 2207, WILMINGTON, DE, 19899, US

(73) Assignee: TICONA GmbH, Kelsterbach (DE)

(21) Appl. No.: 11/596,145

(22) PCT Filed: May 12, 2005
(86) PCT No.: PCT/EP05/05158

§ 371 Date: Jan. 12, 2007

(30) Foreign Application Priority Data
May 13, 2004 (DE) 10 2004 024 061.2

(51) Int. Cl. B29C 45/17

(52) U.S. Cl. 264/483; 427/536

(57) ABSTRACT

A process is described for producing plastics composites comprising a polyacetal molding, onto part or all of at least one surface of which a molding or a coating composed of thermoplastic has been directly molded. The process encompasses the following measures: i) production of a polyacetal molding ii) treating at least one predetermined portion of one of the surfaces of the polyacetal molding with an atmospheric, potential-free plasma, and iii) single or multiple molding-on of the thermoplastic to at least one part of the surface treated with the atmospheric, potential-free plasma. Instead of the polyacetal molding, the molding composed of thermoplastic may be produced first, the polyacetal molding being molded onto this after the plasma treatment. The process can produce polyacetal composites in particular with thermoplastic elastomers, and these feature good adhesion.

The present invention relates to a process for producing polyacetal plastics composites and to an apparatus suitable therefore. The process can produce composites composed of a combination of the industrial material polyoxymethylene with directly molded-on functional elements composed of one or more thermoplastics, especially of thermoplastic elastomers.

The industrial material polyacetal, i.e. polyoxymethylene (hereinafter from referred to as POM or polyacetal), has outstanding mechanical properties and is additionally generally also resistant toward all customary solvents and fuels. Moldings made of polyoxymethylene are therefore used, inter alia, in automobile construction, especially also in fuel-conducting systems.

Owing to the good strength and hardness combined with excellent resilience, moldings composed of polyacetal find very frequent use in all areas of daily life, for example for snap connections, especially clips.

The excellent sliding and frictional properties justify the use of polyoxymethylene for many moving parts, for example transmission parts, deflecting rollers, gearwheels or adjusting levers. Owing to the very good mechanical strength and resistance toward chemicals, housings and keyboards are also produced from polyoxymethylene.

However, POM has a low mechanical damping factor at room temperature, which in some applications necessitates the use of soft damping elements. When moldings composed of polyoxymethylene are incorporated, a seal is additionally often required at connection sites. The high surface hardness of moldings composed of POM and the low coefficient of sliding friction of POM can lead to slippage of adjacent objects and restrict the operational reliability, for example of switching elements and control elements composed of POM.

On the other hand, combinations of hard and soft or of hard and hard materials are also being used ever more often, in order to combine the particular properties of these materials with one another. In the case of a combination of hard and soft material, the hard material should provide the strength of the components; the soft material, owing to its elastic properties, assumes functions with regard to sealing or vibration damping and sound deadening, or brings about an improvement in the surface feel. In the case of the combination of two or more hard materials, they may have different properties which are advantageous for the particular application, or they may be moldings which are composed of the same material and are provided, for example, with different additives.

What is important in these applications is sufficient adhesion between the different components.

To date, one method has been to provide seals and damping elements separately and typically to mechanically anchor or adhesive-bond them in an additional working step, which causes additional work and in some cases considerable additional costs. A newer and more economically viable method is multicomponent injection molding. In this case, for example, a second component is injection-molded onto a preshaped first component. The achievable adhesion between the two components is of great significance for this process. In multicomponent injection molding, this adhesion can often be improved further by introduction of undercuts within interlocking connections. However, good basic adhesion by virtue of chemical affinity between the selected components is often a prerequisite for their use.

Examples of well-known combinations produced by multicomponent injection molding are composed of polypropylene (PP) and polyolefin elastomers or styrene/olefin elastomers, polybutylene terephthalate (PBT) with polyester elastomers or styrene/olefin elastomers. Polyamides too exhibit adhesion to very many soft components.

Thermoplastic elastomers should in principle be combinable with thermoplastics in the overmolding process, and, for example, polyurethane elastomers (TPEU) have adhesion to POM (Kunststoffe 84 (1994) p. 709 and Kunststoffe 86, (1996), p. 319). For combinations of POM with other thermoplastic elastomers, such as with TPEE (polyester elastomers) or TPEA (polyamide elastomers), these documents do not report adhesion.

EP-A-816,043 discloses material combinations of hard thermoplastics, such as POM, and soft thermoplastics.

WO-A-99/16,605 describes material combinations of POM/thermoplastic polyurethane elastomer.

U.S. Pat. No. 6,082,780 discloses tubes around which thermoplastic or elastomer has been injection-molded. A wide variety of different polymers is disclosed for the tube and for the sheath. The materials listed for the tube and/or the sheath include POM and thermoplastic polyester elastomers. In addition to a series of polymer combinations for which adhesive bonds between the materials are possible, this document discloses numerous combinations which do not lead to adhesion.

The prior art has to date not disclosed any process which permits the universal production of adhesive bonds between moldings composed of polyoxymethylene and moldings composed of any other thermoplastics, including POM.

The treatment of polymer surfaces with plasma and the parallel or subsequent coating of the treated surface is known per se.

For instance, DE-A-102 23 865 describes a process and an apparatus for the plasma coating of workpieces, in which one component of the coating material is present as a solid in an electrode of the plasma nozzle and is applied to the surface to be treated by sputtering.

EP-A-376,141 describes a process and an apparatus for the polymer coating of extruded profiles. In this process, an extruded profile composed of polymer is conducted continuously through a reactor in which a monomer is polymerized with the aid of a microwave-generated plasma and is deposited on the extruded profile.

The plasma treatment of large-surface area polymer surfaces for the controlled adjustment of surface properties is also already known. For instance, WO-A-01/43,512 describes a plasma nozzle which has a compact structure and permits large-surface area treatment of the surfaces of workpieces. It can be taken from this document that the plasma treatment improves the wettability of polymer surfaces with, for example, adhesives or printing inks.

Proceeding from this prior art, it is an object of the present invention to provide novel composites composed of polyacetal with directly molded-on functional elements composed of thermoplastics, preferably soft components, which feature high bond strengths.

It is a further object of the present invention to provide a simple process and an apparatus suitable for performing this process, with which the composite composed of polyacetal can be produced with directly molded-on functional elements composed of a multitude of thermoplastics or in particular thermoplastic elastomers, which have high bond strengths.

The present invention relates to a process for producing plastics composites comprising a polyacetal molding, onto part or all of at least one surface of which a molding or a coating comprising thermoplastic has been directly molded, encompassing the following measures:
i) production of a polyacetal molding,
ii) treating at least one predetermined portion of one of the surfaces of the polyacetal molding with an atmospheric, potential-free plasma, and
iii) single or multiple molding-on of the thermoplastic to at least one part of the surface treated with the atmospheric, potential-free plasma.

The process according to the invention may also comprise a different sequence of measures. The invention therefore also relates to a process for producing plastics composites comprising a molding composed of thermoplastic, onto part or all of at least one surface of which a polyacetal molding or a coating composed of polyacetal has been directly molded, encompassing the following measures:
iv) production of a molding composed of thermoplastic,
v) treating at least one predetermined portion of one of the surfaces of the molding composed of thermoplastic with an atmospheric, potential-free plasma, and
vi) single or multiple molding-on of polyacetal to at least one part of the surface treated with the atmospheric, potential-free plasma.

The polyacetal molding or the molding comprising thermoplastic can be produced in any way, for example by injection molding or by extrusion.

Preference is given to producing the molding in steps i) or iv) by injection molding.

The thermoplastic can be molded onto the plasma-treated POM molding or the POM can be molded onto the plasma-treated molding comprising thermoplastic likewise in any way, for example by extrusion of the material onto the plasma-treated surface of the molding or preferably by multicomponent injection molding or by subsequent overmolding.

The plasma treatment of the at least one surface of the molding in steps ii) or v) of the process according to the invention can be effected by means of any atmospheric, potential-free plasmas.

This is understood to mean plasmas which burn at ambient pressure and in which the molding to be treated need not be contacted with a counterelectrode for plasma generation.

For the plasma treatment, preference is given to using the plasma nozzle known from WO-A-01/43,512. The treatment with the atmospheric, potential-free plasma takes place via movement, across the surface of the polyacetal molding, of a tubular, electrically conductive housing which forms a nozzle duct through which an operating gas flows and in which a plasma is produced, and the outlet of which takes the form of a narrow slot running perpendicularly with respect to the longitudinal axis of the nozzle duct, or a predetermined portion of the surface to be treated of the molding to be treated is moved across this type of plasma nozzle which has been attached immovably.

The plasma treatment can also take place more than once, for example from 2 to 10 times. However, the plasma treatment of the predetermined portion of the surface of the molding to be treated preferably takes place once.

The operating gases used may be any gases, such as air, nitrogen, oxygen, argon, xenon, hydrogen or a mixture of two or more of these gases. If appropriate, reactive constituents can be added thereto, such as saturated or unsaturated hydrocarbons or silanes.

The energy of the ions of the plasma meeting the surface to be treated and/or the reaction with reactive gas constituents present in the beam fully discharges the surface and effectively freeze it of impurities. Depending on the additive in the operating gas, it is also possible to form surface layers in a controlled manner. The plasma treatment can also transmit thermal energy to the surface in a controlled manner.

The process according to the invention allows the production of composites which are formed by a polyacetal molding which is coated partly or fully with the second component composed of thermoplastic, or onto which one or more moldings composed of the second component composed of thermoplastic have been molded directly, or a molding composed of the second component of thermoplastic has been coated partly or fully with polyacetal and one or more moldings composed of polyacetal have been molded-on directly, the polyacetal and the second component being bonded to one another adhesively or cohesively and the bond strength on tensile stress between the polyacetal and the second component being at least 0.5 N/mm², preferably at least 1.0 N/mm². This ensures impeccable handling. For functional parts, higher adhesion is desirable depending on the stress. In the context of this description, “second component” or “second thermoplastic component” is also understood to mean a plurality of moldings or layers composed of different thermoplastics.

According to the invention, the hard component and, if appropriate, also the second component used may be any polyacetal, specifically from the group of the known polyoxymethylenes as described, for example, in DE-A 29 47 490. These are generally unbranched linear polymers which contain generally at least 80 mol %, preferably at least 90 mol %, of oxymethylene units (—CH₂—O—). The term polyoxymethylenes encompasses both homopolymers of formaldehyde or its cyclic oligomers such as trioxane or tetraoxane, and corresponding copolymers.

Homopolymers of formaldehyde or trioxane are those polymers whose hydroxyl end groups have been stabilized chemically against degradation in a known manner, for example by esterification or etherification.

Copolymers are polymers composed of formaldehyde or its cyclic oligomers, especially trioxane, and cyclic ethers, cyclic acetals and/or linear polyacetals.

The comonomers used may be i) cyclic ethers having 3, 4 or 5, preferably 3 ring members, ii) cyclic acetals other than trioxane having from 5 to 11, preferably 5, 6, 7 or 8 ring members, and iii) linear polyacetals, in each case in amounts of from 0.1 to 20 mol %, preferably from 0.5 to 10 mol %.

The polyacetal polymers used generally have a melt flow index (190/2.16 MFI value) of from 0.5 to 75 g/10 min (ISO 1133). It is also possible to use modified POM types which comprise, for example, impact modifiers, reinforcers such as glass fibers, or other additives.

These modified POM types include, for example, blends of POM with TPEU (thermoplastic polyurethane elastomer), with MBS (methyl methacrylate/butadiene/styrene core-shell elastomer), with methylmethacrylate/acrylate core-shell elastomer, with PC (polycarbonate), with SAN (styrene/acrylonitrile copolymer) or with ASA (acrylate/styrene/acrylonitrile copolymer compound).

According to the invention, the second component used may be any thermoplastic or combinations of any thermoplastics.

In the context of the invention, the thermoplastics usable are in principle all known synthetic, natural and modified natural polymers which can be processed by melt extrusion.

Examples include:

polylactones, such as poly(pivalolactone) or poly(caprolactone);

polyurethanes, such as the polymerization products of the diisocyanates, for example of naphthalene 1,5-diisocyanate; p-phenylene diisocyanate; m-phenylene diisocyanate, tolylene 2,4-diisocyanate, tolylene 2,6-diisocyanate, diphenylmethane 4,4′-diisocyanate, 3,3′-dimethylbiphenyl 4,4′-diisocyanate, diphenylisopropylidene 4,4′-diisocyanate, 3,3′-dimethyidiphenyl 4,4′-diisocyanate, 3,3′-dimethyldiphenylmethane 4,4′-diisocyanate, 3,3′-dimethoxybiphenyl 4,4′-diisocyanate, dianisidine diisocyanate, toluidine diisocyanate, hexamethylene diisocyanate, 4,4′-diisocyanatodiphenylmethane, hexamethylene 1,6-diisocyanate, or dicyclohexylmethane 4,4′-diisocyanate with polyesters derived from long-chain diols, such as poly(tetramethylene adipate), poly(ethylene adipate), poly(butylene 1,4-adipate), poly(ethylene succinate), poly(butylene 2,3-succinate), derived from polyether diols, and/or with one or more diols such as ethylene glycol, propylene glycol, and/or with polyether diols derived from one or more diols, e.g. diethylene glycol, triethylene glycol, and/or tetraethylene glycol;

polycarbonates, such as poly[methanebis(phenyl 4-carbonate)], poly[1,1-etherbis(phenyl 4-carbonate)], poly[diphenylmethanebis(phenyl 4-carbonate)], and poly[1,1-cyclohexanebis(phenyl 4-carbonate)];

polysulfones, such as the reaction product of the sodium salt of 2,2-bis(4-hydroxyphenyl)propane or of 4,4′-dihydroxydiphenyl ether with 4,4′-dichlorodiphenyl sulfone;

polyethers, polyketones, and polyether ketones, such as polymerization products of hydroquinone, of 4,4′-dihydroxybiphenyl, of 4,4′-dihydroxybenzophenone, or of 4,4′-dihydroxydiphenylsulfone with dihalogenated, in particular difluorinated or dichlorinated, aromatic compounds of the type represented by 4,4′-dihalodiphenyl sulfone, 4,4′-dihalodibenzophenone, bis(4,4′-dihalobenzoyl)benzene, and 4,4′-dihalobiphenyl;

polyamides, such as poly(4-aminobutanoate), poly(hexamethylene-adipamide), poly(6-aminohexanoate), poly(m-xylyleneadipamide), poly(p-xylylenesebacamide), poly(2,2,2-trimethylhexamethyleneterephthalamide), poly(meta-phenyleneisophthalamide) (NOMEX), poly(p-phenylene-terephthalamide) (KEVLAR) and preferably aliphatic polyamides, in particular nylon-6(polyamide 6), nylon-6,6(polyamide 66) and copolymers thereof;

polyesters, such as poly(ethylene 1,5-naphthalate), poly(cyclohexane-1,4-dimethylene terephthalate), poly(ethylene oxybenzoate) (A-TELL), poly(para-hydroxybenzoate) (EKONOL), poly(cyclohexylidene-1,4-dimethylene terephthalate) (KODEL), polyethylene terephthalate, and polybutylene terephthalate;

poly(arylene oxides), such as poly(2,6-dimethylphenylene 1,4-oxide), and poly(2,6-diphenylphenylene 1,4-oxide);

liquid-crystalline polymers, such as the polycondensation products from the group of monomers consisting of terephthalic acid, isophthalic acid, naphthalene-1,4-dicarboxylic acid, naphthalene-2,6-dicarboxylic acid, biphenyl-4,4′-dicarboxylic acid, 4-hydroxybenzoic acid, 6-hydroxy-2-naphthalenedicarboxylic acid, hydroquinone, 4,4′-dihydroxybiphenyl, and 4-aminophenol;

poly(arylene sulfides), such as poly(phenylene sulfide), poly(phenylene sulfide ketone), and poly(phenylene sulfide sulfone);

polyetherimides;

vinyl polymers and their copolymers, such as polyvinyl acetate, polyvinyl chloride, polyvinyl butyral, polyvinylidene chloride, and ethylene-vinyl acetate copolymers;

polyacrylic derivatives, such as polyacrylate and polymethacrylate and their copolymers and derivatives, such as esters, for example polyethyl acrylate, poly(n-butyl acrylate), poly(methyl methacrylate), poly(ethyl methacrylate), poly(n-butyl methacrylate), poly(n-propyl methacrylate), polyacrylonitrile, water-insoluble ethylene-acrylic acid copolymers, water-insoluble ethylene-vinyl alcohol copolymers, acrylonitrile copolymers, methyl methacrylate-styrene copolymers, ethylene-ethyl acrylate copolymers, and acrylic-butadiene-styrene copolymers; polyolefins, such as poly(ethylene), e.g. low-density poly(ethylene) (LDPE); linear low-density poly(ethylene) (LLDPE) or high-density poly(ethylene) (HDPE);

poly(propylene), chlorinated poly(ethylene), e.g. chlorinated low-density poly(ethylene); poly(4-methyl-1-pentene), and (poly)styrene);

water-insoluble ionomers; poly(epichlorohydrin);

furan polymers, such as poly(furan);

polyoxymethylene homo- or copolymers;

cellulose esters, such as cellulose acetate, cellulose acetate butyrate, and cellulose propionate;

silicones, such as poly(dimethylsiloxane), and poly(dimethylsiloxane-co-phenylmethylsiloxane);

protein thermoplastics;

and also all of the mixtures and alloys (miscible and immiscible blends) of two or more of the polymers mentioned.

For the purposes of the invention, thermoplastic polymers preferably encompass thermoplastic elastomers derived, for example, from one or more of the following polymers:

polyurethane elastomers, fluoroelastomers, polyester elastomers, polyamide elastomers, polyvinyl chloride, thermoplastic butadiene/acrylonitrile elastomers, thermoplastic poly(butadiene), thermoplastic poly(isobutylene), ethylene-propylene copolymers, thermoplastic ethylene-propylene-diene terpolymers, thermoplastic sulfonated ethylene-propylene-diene terpolymers, poly(chloroprene), thermoplastic poly(2,3-dimethylbutadiene), thermoplastic poly(butadiene-pentadiene), chlorosulfonated poly(ethylene), block copolymers composed of segments of amorphous or (semi)crystalline blocks, such as poly(styrene), poly(vinyltoluene), poly(tert-butylstyrene), and polyesters, and of elastomeric blocks, such as poly(butadiene), poly(isoprene), ethylene-propylene copolymers, ethylene-butylene copolymers, ethylene-isoprene copolymers, and their hydrogenated derivatives, for example SBS, SEBS, SEPS, SEEPS, and also hydrogenated ethylene-isoprene copolymers having an increased proportion of 1,2-linked isoprene, polyethers, styrene polymers, such as ASA (acrylonitrile-styrene-acrylate), ABS (acrylonitrile-butadiene-styrene), or PC/ABS (polycarbonate/ABS) and the like, for example the products marketed with the trade mark KRATON from Kraton Polymers, and also any of the mixtures and alloys (miscible and immiscible blends) of two or more of the polymers mentioned.

Thermoplastic elastomers to be used particularly advantageously are thermoplastic elastomeric polyurethanes (TPEU), thermoplastic elastomeric polyesters (TPEE), thermoplastic elastomeric polyamides (TPEA), thermoplastic elastomers based on styrene (TPES), especially SEBS and SBS (S=styrene, B=butadiene, E=ethylene), and crosslinkable thermoplastic elastomers based on olefin (TPE-V), such as EPDM types, or a combination of two or more of these polymers.

The second component used is preferably a thermoplastic elastomer or a combination thereof, or a plurality of molded-on parts composed of the same or different thermoplastic elastomers.

Further preferred combinations are POM moldings, onto which is molded, as the second component, a molding composed of polyoxymethylene homo- or copolymer, composed of polyamide or composed of polyester, or a plurality of moldings composed of identical or different polymers selected from polyoxymethylene homo- or copolymers, composed of polyamide or composed of polyester.

Very particular preference is given to a process in which prior to the injection-molding process for molding-on of the thermoplastic elastomer, the polyacetal molding is preheated to a temperature in the range from 100 to 160° C., and during the injection-molding process for molding onto the polyacetal molding the melt temperature of the thermoplastic elastomer is from 180 to 280° C., and the mold has been temperature-controlled to a temperature in the range from 20 to 140° C.

The invention also relates to an apparatus for producing the above-described plastics composites. The apparatus comprises the combination of:
a) a machine for producing a molding from thermoplastic polymer,
b) a machine for treating at least one predetermined portion of at least one of the surfaces of the molding composed of thermoplastic polymer with an atmospheric, potential-free plasma, and
c) a machine for molding at least one thermoplastic onto at least one part of the surface treated with the atmospheric, potential-free plasma.

The machines a) and c) may be any apparatus for producing moldings, for example extruders or injection-molding apparatus. They may be two different machines or different parts of one apparatus.

Machines a) and c) are preferably injection molding apparatus.

Most preferably, machines a) and c) are a multicomponent injection-molding apparatus. This can be operated with any molds and process techniques.

Examples thereof are core pullback methods, transfer injection-molding methods, apparatus in which molds with turntables are used, apparatus in which molds with index plates are used, apparatus in which staged rotation systems are used and apparatus in which cubic molds are used.

Machine b) may be any apparatus for the treatment of surfaces or parts of surfaces with atmospheric, potential-free plasma. It may be a separate machine or it is part of one apparatus, for example a combination with machine a) or c) or a) and c).

For treatment with an atmospheric, potential-free plasma, preference is given to using a machine b) which encompasses a tubular, electrically conductive housing which forms a nozzle duct through which an operating gas flows, and which has an electrode arranged coaxially in the nozzle duct and a high-frequency generator for applying a potential between the electrode and the housing, and whose outlet takes the form of a narrow slot running perpendicularly with respect to the longitudinal axis of the nozzle duct.

In a particularly preferred embodiment, this machine for the treatment with an atmospheric, potential-free plasma has been integrated into a multicomponent injection-molding apparatus.

In a further particularly preferred embodiment, the mold in which the molding composed of thermoplastic polymer is disposed during the plasma treatment is heatable or permits the heating of the polymer molding.

The polyacetal and/or thermoplastic used in accordance with the invention may comprise customary additives such as stabilizers, nucleating agents, demolding agents, lubricants, fillers and reinforcers, pigments, carbon black, light stabilizers and flame retardants, antistats, adhesion promoters, plasticizers or optical brighteners. The additives are present in customary amounts.

The moldings composed of polyacetal and thermoplastic preferably do not comprise any additional adhesion promoter, since the plasma treatment already ensures sufficient adhesion of the moldings.

The process according to the invention leads, by virtue of simple measures, surprisingly to moldings with improved adhesion in a multitude of polymer combinations. It is economically viable and advantageous to use the multicomponent injection-molding process, in which the polyacetal is first shaped, i.e. premolded, in the injection mold, then the plasma treatment of at least one of the surfaces of the preform is effected and a coating or a molding composed of the thermoplastic is subsequently injection-molded onto the polyacetal molding. Instead, it is possible initially to shape, i.e. premold, the molding composed of the thermoplastic in the injection mold, then to treat at least one of the surfaces of the preform with plasma and subsequently to injection-mold a coating or a molding composed of the polyacetal onto the thermoplastic molding. The preferred variant of the process, in which a polyacetal molding is first prepared, onto which, after the plasma treatment, a molding composed of thermoplastic is injection-molded or which is overmolded with thermoplastic, is described below.

When the molding is produced, the melt temperature is within the customary range, i.e., for the above-described polyacetals, in the range from about 180 to 280° C., preferably from 190 to 230° C. The mold itself is preferably temperature-controlled to a temperature in the range from 20 to 140° C. For the shaping precision and dimensional stability of the hard component composed of the semicrystalline polyacetal material, a mold temperature in the upper temperature range is advantageous.

After the production of the polyacetal molding, the preform is then treated with the atmospheric, potential-free plasma in a second, subsequent step. This is effected typically by moving the activated treatment apparatus across the surface of the preform or by moving a predetermined surface of the preform through the atmospheric, potential-free plasma which is generated in an immovable plasma generator. In a further injection-molding step, this treated preform is then, for example, placed or transferred into another mold with a recessed cavity, or the treated preform remains in the mold and the second thermoplastic material, preferably the soft component, is sprayed into the mold and injection-molded onto the polyacetal molding. For the adhesion achievable thereafter, it is particularly advantageous when the premolded polyacetal molding is preheated to a temperature in the range from 80° C. up to just below the melting point. This facilitates partial melting of the surface by the second thermoplastic component which is injection-molded on and its penetration into the interface layer.

If appropriate, it is possible in the multicomponent injection molding process for further moldings composed of polyacetal and the second thermoplastic component to be injection-molded on simultaneously or in successive steps.

The plasma treatment is effected typically at ambient pressure and at ambient temperatures, typically at temperatures of from 20 to 45° C.

The plasma treatment can be performed as soon as the polyacetal molding has finished cooling, or is effected preferably at elevated surface temperatures of the polyacetal molding to be treated. It has been found that, surprisingly, elevated surface temperatures of the polyacetal molding in the plasma treatment lead to another significant increase in bond strengths of the molding. The temperature of the surface to be treated is preferably from 60 to 155° C.

A plasma nozzle is preferably brought close to at least one surface of the demolded or partly demolded POM molding, so that the plasma can come into contact with the surface.

When the soft component is injection-molded on, it is advantageous for good adhesion to select the settings for the melt temperature as high as possible. In general, the melt temperature of the second thermoplastic component is in the range from 150 to 300° C. and its upper limit is caused by its decomposition. The values of the injection rate and for the injection pressure and hold pressure are machine- and molding-dependent and should be adjusted to the particular circumstances.

In all process variants, with or without demolding of the preform, the mold in the second step is temperature-controlled to a temperature in the range of preferably from 20° C. to 140° C. Depending on the construction of the parts, it may be sensible to lower the mold temperature somewhat, in order thus to optimize the demoldability and the cycle times. After the cooling of the parts, the composite is demolded. In this context, it is important in the mold construction to mount the ejectors at a suitable point in order to minimize stress on the material composite seam. Sufficient venting of the cavity in the seam region is also provided in the mold construction in order to minimize hindrance of the bonding between the two components by included air. The type of tool roughness also exerts a similar influence.

The process according to the invention provides flat polyacetal moldings which bear, on one side, a layer of the second thermoplastic component, preferably of the soft component. Examples thereof are slip-resistant substrates, recessed handles, control and connecting elements, functional parts provided with seals or damping elements, and inner and outer paneling of bicycles, motor vehicles, aircraft, rail vehicles and watercraft, which obtain the desired dimensional stability through the polyacetal, and the desired frictional property, sealant function, feel or appearance through the layer composed of the second thermoplastic.

However, the process according to the invention can also provide one or more polyacetal moldings of any shape, onto which one or more moldings of any shape composed of the second thermoplastic component have been injection-molded directly.

The process according to the invention makes it possible to mold moldings composed of polyacetal and at least one further identical or different thermoplastic with high adhesion to one another, or to coat polyacetal moldings with polyacetal or another thermoplastic with high adhesive strength. The adhesive strength can be determined by the so-called roller peel test to DIN EN 1467.

Moldings produced with preference comprise at least one polyacetal molding and at least one molding which has been injection-molded onto it directly and comprises a second thermoplastic or a coating comprising a second thermoplastic, the second thermoplastic used being a thermoplastic elastomer.

The use of soft components allows, for example, sealing or damping elements thereof to be injection-molded directly onto moldings composed of polyacetal without further assembly steps being required.

As a result of the absence of the processing steps required to date for the assembly of functional elements, a considerable cost saving can be achieved in the production of the inventive composites.

The adhesion strength between the hard polyacetal component and the second thermoplastic component, preferably the soft component, can be determined by means of a measurement process described in WO-A-99/16,605.

The examples which follow illustrate the invention without restricting it.

### EXAMPLES 1-6

For the injection-molding experiments, a conventional multicomponent injection-molding machine. In a conventional injection mold, a plaque-shaped preform was first produced from POM. A portion of the surface of this preform was treated with a plasma nozzle described from WO-A-01/43,512. Subsequently, the second component was injection-molded onto the treated portions and the untreated portions of the surface.

The moldings which are composed of two components and are obtained in this way were tested in the roller peel test to DIN EN 1467 with a pulling speed of 50 mm/min. The force which was required to remove the layers composed of polyacetal and soft component was determined from the result of the roller peel test. For each experiment, several specimens were tested. The values determined for the specimens were averaged.

The details of the materials used and the results obtained are listed in the table below.

| | | | Roller peel | | |
|---|---|---|---|---|---|
| | | | resistance | Roller peel | Surface |
| | | | without | resistance | temperature |
| | | | plasma | with plasma | of the |
| | Hard | | pretreatment⁵⁾ | pretreatment⁵⁾ | preform |
| Ex. No. | component | Soft component | (N/mm) | (N/mm) | (° C.) |
| 1 | C | component | 1.00 | 1.2 | 23 |
| | 9021¹⁾ | A²⁾ | | | |
| 2 | C | component | no adhesion | 0.4 | 23 |
| | 9021¹⁾ | B³⁾ | | | |
| 3 | C | component | 5.8 | 7.5 | 23 |
| | 9021¹⁾ | C⁴⁾ | | | |
| 4 | C9021 | component | no adhesion | 0.8 | 120 |
| | | B³⁾ | | | |
| 5 | C9021 | component | 0.2 | 1.0 | 150 |
| | | B³⁾ | | | |
| 6 | C9021 | component | 5.8 | 8.8 | 120 |
| | | C⁴⁾ | | | |

¹⁾Hostaform ® C 9021: polyoxymethylene copolymer composed of trioxane and about 2% by weight of ethylene oxide, melt index MFR 190/2.16 (ISO 1133): 9 g/10 min, no modification (Ticona GmbH)
²⁾SEBS Shore A 45, adhesion-modified
³⁾SEBS Shore A 52, not adhesion-modified
⁴⁾SEBS Shore A 58, adhesion-modified
⁵⁾Roller peel test to DIN EN 1467

1. A process for producing plastics composites comprising a polyacetal molding, onto part or all of at least one surface of which a molding or a coating comprising thermoplastic has been directly molded, encompassing the following steps:
i) producing a polyacetal molding
ii) treating at least one predetermined portion of one of the surfaces of the polyacetal molding with an atmospheric, potential-free plasma, and
iii) single or multiple molding-on of the thermoplastic to at least one part of the surface treated with the atmospheric, potential-free plasma.

2. The process for producing plastics composites comprising a molding composed of thermoplastic, onto part or all of at least one surface of which a polyacetal molding or a polyacetal coating has been directly molded, encompassing the following steps:
i) producing a molding composed of thermoplastic,
ii) treating at least one predetermined portion of one of the surfaces of the molding composed of thermoplastic with an atmospheric, potential-free plasma, and
iii) single or multiple molding-on of polyacetal to at least one part of the surface treated with the atmospheric, potential-free plasma.

3. The process as claimed in claim 1, wherein the production of the polyacetal molding and/or of the molding composed of thermoplastic takes place via injection molding.

4. The process as claimed in claim 1, wherein the molding-on of the thermoplastic or of the polyacetal takes place via multicomponent injection molding.

5. The process as claimed in claim 1, wherein the treatment of the at least one predetermined portion of the at least one surface of the molding with the atmospheric, potential-free plasma takes place via movement, across the predetermined portion of the surface of the molding, of a tubular, electrically conductive housing which forms a nozzle duct through which an operating gas flows and in which a plasma is produced, and the outlet of which takes the form of a narrow slot running perpendicularly with respect to the longitudinal axis of the nozzle duct, or via movement of a predetermined part of the surface to be treated of the molding across this type of plasma nozzle which has been attached immovably.

6. The process as claimed in claim 1, wherein the plasma treatment takes place once.

7. The process as claimed in claim 1, wherein step ii) takes place at surface temperatures of the polyacetal molding to be treated of from 60 to 155° C.

8. The process as claimed in claim 1, wherein the thermoplastic used comprises a thermoplastic elastomer.

9. The process as claimed in claim 8, wherein the thermoplastic elastomer used comprises a thermoplastic elastomeric polyurethane (TPEU), thermoplastic elastomeric polyester (TPEE), thermoplastic elastomeric polyamide (TPEA), thermoplastic elastomer based on styrene (TPES), crosslinkable thermoplastic elastomer based on olefin (TPEV), or a combination of two or more of these polymers.

10. The process as claimed in claim 1, wherein the thermoplastic used comprises polyoxymethylene homo- or copolymer, polyamide, or polyester, or wherein two or more moldings composed of identical or different polymers selected from these polymers have been molded onto the polyacetal molding.

11. The process as claimed in claim 8, wherein, prior to the injection-molding process for molding-on of the thermoplastic elastomer, the polyacetal molding is preheated to a temperature in the range from 100 to 160° C., and during the injection-molding process for molding onto the polyacetal molding the melt temperature of the thermoplastic elastomer is from 180 to 280° C., and the mold has been temperature-controlled to a temperature in the range from 20 to 140° C.

12. An apparatus for producing plastics composites as claimed in claim 1, encompassing the following combination:
a) a machine for producing a molding from thermoplastic polymer,
b) a machine for treating at least one predetermined portion of at least one of the surfaces of the molding composed of thermoplastic polymer with an atmospheric, potential-free plasma, and
c) a machine for molding at least one thermoplastic onto at least one part of the surface treated with the atmospheric, potential-free plasma.

13. The apparatus as claimed in claim 12, wherein machines a) and c) are injection-molding apparatus.

14. The apparatus as claimed in claim 12, wherein machines a) and c) are multicomponent injection-molding apparatus.

15. The apparatus as claimed in claim 12, wherein the machine for the treatment with an atmospheric, potential-free plasma encompasses a tubular, electrically conductive housing which forms a nozzle duct through which an operating gas flows, and which has an electrode arranged coaxially in the nozzle duct and a high-frequency generator for applying a potential between the electrode and the housing, and whose outlet takes the form of a narrow slot running perpendicularly with respect to the longitudinal axis of the nozzle duct.

16. The apparatus as claimed in claim 15, wherein the machine for the treatment with an atmospheric, potential-free plasma has been integrated into a multicomponent injection-molding apparatus.

17. The apparatus as claimed in claim 15, wherein the mold in which the molding composed of thermoplastic polymer is disposed during the plasma treatment is heatable or permits the heating of the molding composed of thermoplastic polymer.
